(19) United States
(12) Patent Application Publication
(10) Pub. No.: US 2019/0126465 A1
(43) Pub. Date: May 2, 2019

(54) DRIVE UNIT FOR A MANIPULATOR

(71) Applicant: KBee AG, Munich (DE)

(72) Inventors: Sami Haddadin, Hannover (DE); Tim Rokahr, Munich (DE); Patrick Leyendecker, Graelfelfing (DE); Niklas Boehme, Munich (DE)

(73) Assignee: KBee AG, Munich (DE)

(21) Appl. No.: 16/095,332

(22) PCT Filed: Apr. 20, 2017
(86) PCT No.: PCT/EP2017/059446

§ 371 Date: Oct. 19, 2018

(30) Foreign Application Priority Data
Apr. 20, 2016 (DE) 10 2016 004 810.7

(51) Int. Cl. B25J 9/12; B25J 19/02; B25J 17/00

(52) U.S. Cl. CPC B25J 9/12; B25J 17/00; B25J 19/02

(57) ABSTRACT

The present invention relates to a drive unit for a joint being arranged between two arm members of a manipulator of a robotic system and for the rotatory drive of one arm member in relation to one other arm member, with a motor which drives a drive shaft, with an output element, which is connected with the one arm member and which is directly or indirectly set into rotation by means of the drive shaft, and with a circuit board, on which a sensor device for the drive as provided by the drive shaft and a sensor device for the output as provided by the output element are arranged.

The present invention relates to a drive device or unit with respect to a joint being arranged between two arm or axle members of a manipulator of a robotic system.

Drive units, which are used in manipulators of robotic systems and robot arms, respectively, are intended to arrange one axle or arm member relatively movably, preferably rotatably, in relation to a subsequent arm member of a robot arm, which usually is configured with a plurality of axes. The movability between two adjacent arm members being realized thereby results in corresponding degrees of freedom of the robotic system depending on the number of the arm members of the manipulator.

In this connection, drive units for industrial robots are employed which allow a rotation of an arm member around an axis being traverse to its longitudinal extension. Further drive units are configured to allow a rotation around the longitudinal axis of the arm member. For that purpose, usually correspondingly dimensioned electric motors are used, which, where appropriate, cooperate with corresponding reduction gears.

With respect to light-weight robots, the drive units are mounted inside the closed housing of the arm member, since the housings of manipulators of robots of such kind are in principle configured as exoskeletons.

Normally, in drive units as known in the prior art at least one sensor device is provided at the side of the output in order to detect the position, the torque and/or the rotational speed of an output element, which sets the one arm member in rotation relative to the other arm member. In order to detect the input or drive rotational speed, the drive torque and/or the position of an input or drive shaft being driven by a motor, moreover, a further sensor device is provided at the side of the motor and at the side of the input, respectively.

Each sensor device usually is located on a separate circuit board or printed circuit board (PCB), respectively, which circuit boards are arranged at corresponding locations of the drive unit.

One circuit board having a sensor device for the input therefor is located in the area of the motor or the drive shaft being activated by it, in which the motor is received within that arm member, which is rotatably supported against the other arm member. Therefore, the circuit board, which could also contain the entire control electronics assembly for the drive unit, comprises one position sensor only for the detection of the input or drive.

Detection of the output is performed by a second position sensor, which is located on an independent circuit board, which is configured entirely separate from the circuit board containing the first position sensor both with respect to spatial and signaling aspects. This circuit board is located within the drive unit in the area of the output, i.e. in cooperation with an output element, for example an output flange or an output housing, which usually are provided in the housing of the arm member being rotatably supported.

However, using a position sensor being located in this area together with a stand-alone circuit board containing said position sensor is associated with the drawback, that on the one hand the second position sensor has to be accurately aligned within the drive unit, which leads to errors, and that on the other the signals generated by it have to be transmitted via wires to the circuit board with the first position sensor for the drive, which circuit board is arranged axially opposite to the output and which contains the control and evaluation electronics assembly.

Therefore, only one position sensor per circuit board can be read by the evaluation electronics assembly.

With respect to exoskeleton-type housings of light-weight robotic systems, however, the problem exists that the drive units with all components have to be inserted axially into the housings of the arm members due to the self-contained, completely encased housing structures and have to be mounted there in a cumbersome way due to the very restricted access. This also comes true with respect to wiring which leads from the output side to the input drive side.

Moreover, there is the problem that a simple wiring will not be sufficient in order to directly detect the signal being generated by the output side sensor device, since this signal may be deteriorated upon its passage through the drive unit to the circuit board containing the drive side position sensor and past the electric motor. Therefore a corresponding data bus is usually required, which increases the costs with respect to the electronics assembly for such drive unit.

Further, in case the movable components of the drive unit and thus the arm members do mutually rotate, torsional stresses are exposed to the wires leading from the output side circuit board to the input side circuit board, which extend at least along a part of the length of the drive unit, if not along the entire axial length. After a certain period this may result in a malfunction of the wiring.

If furthermore a torque sensor is employed in the drive unit, which is arranged itself on a stand-alone circuit board, already three different circuit boards have to be arranged within the drive unit, which increases the required assembly space or which substantially reduces the actually available assembly space depending on the housing structures of the arm members. Thereby, wiring becomes even more complicated.

Finally it has to be noted that the number of circuit boards for the single sensor devices and the wiring required for it with respect to the drive units as known in the prior art basically increases the assembly efforts in connection with the single mechatronic components, so that the costs for the manufacture of the mechatronic and mechanic components as well as for the assembly and also the maintenance of the drive unit will increase significantly.

Based on that it is an object of the present invention to provide a drive unit with respect to a joint between two arm members of a manipulator of a robotic system, in particular, but not exclusively of the light-weight kind, which overcomes the afore-mentioned disadvantages as known from the prior art, and which in particular enables a simplified assembly of the sensor devices and their maintenance as well as increases the reliability with respect to the detection of the input- and output-side related parameters.

Such object is solved by a drive unit according to claim 1.

Thus, the invention relates to a drive unit for a joint being arranged between two arm members of a manipulator of a robotic system, the drive unit being intended for the rotational drive of the one arm member relative to the other arm member, and the drive unit having a motor, which drives a drive shaft, and an output element which is connected to the one arm member and which is set into rotation directly or indirectly by the drive shaft, in which a circuit board or a printed circuit board (PCB) is provided, on which circuit board a sensor device for the drive as provided by the drive shaft and a sensor device for the output as provided by the output element are arranged.

Contrary to the prior art thus only one single circuit board is employed which carries all necessary sensor components, which include at least one position sensor with respect to the drive and at least one position sensor with respect to the output and which could, if applicable, comprise still further sensors, such as a torque sensor.

According to one preferred embodiment thereby the sensor device for the drive and the sensor device for the output shall be arranged on opposing sides of the circuit board.

An advantage that both sensor devices are directly mounted on one single circuit board, which circuit board is arranged axially opposite to the output element of the drive unit, e.g. at or on top of a motor housing, lies in the fact that an updating procedure of e.g. the firmware with respect to all sensors has to be performed only once, since no position sensor for the output is spatially separated from this circuit board and arranged on a further circuit board.

Complex wiring is not necessary anymore so that the disadvantages associated with such wiring, such as need for space, torsional stresses etc. are completely dropped.

Power supply of the sensor devices as well as the evaluation electronics assembly are directly located on the single circuit board. Since thereby less electric components and connections are spread along the drive unit, such drive unit basically is better prepared against failures.

Calibration of the sensor devices can be directly carried out for the assembled drive unit in a simple manner, in which all data with respect to control, calibration etc. for both sensor devices can be stored in one common memory of the circuit board.

In order to enable that the drive-side and output-side related parameters can be detected by means of sensor devices being arranged on one single circuit board, it is provided according to the invention that the drive shaft being actuated by the motor is configured as a hollow shaft and that the output element is coupled with a sensor shaft in a rotationally fixed, i.e. torque-transmitting manner, in which the sensor shaft traverses the drive shaft with a radial distance and extends as far as to the circuit board.

The sensor shaft may extend through an opening in the circuit board towards the side of it which is opposite to the motor, while the drive shaft of the motor may extend up to the side of the circuit board, which faces the motor.

According to the invention it is provided that a sensor ring is arranged at the face-side axial end of the sensor shaft above the circuit board, which sensor ring cooperates with the sensor device for the output, which is arranged at said side of the circuit board.

In similar fashion the drive shaft carries a sensor ring at its face-side axial end, which faces the circuit board, as well, which sensor ring cooperates with the sensor device for the drive/input, which is arranged at the side of the circuit board, which faces the motor.

The sensor rings each may comprise at least one magnetic element or a series of magnetic elements, in which the corresponding sensor device or corresponding sensor chip, respectively, is configured to detect the respective position of the magnetic sensor ring using the Hall-effect.

Preferably, the sensor devices for both the output and the input are sensors of the same type, which further enhances the evaluation electronics.

While the output is sensed absolutely via the actual position of the sensor ring for the output, since the latter only performs a rotation of at maximum or less than 360°, the drive/input, i.e. the position of the motor, is computed from the number of rotations as carried out by the drive shaft in connection with the actual output position of the output element and in consideration of a gear ratio of a reduction gear usually employed in connection therewith.

In order to keep the detection of signals for both the output and the input as less error-prone as possible, it is of advantage if the distances between the sensor rings and the sensor chips are kept within certain tolerance limits. In addition, inclinations of the sensor rings relative to the sensor chips should be avoided.

According to a preferred embodiment of the invention it is thus provided that the sensor ring for the input and the sensor ring for the output are congruently arranged to both sides of the circuit board and, more preferably, that the sensor device being associated to the sensor ring for the output and the sensor device being associated to the sensor ring for the input are arranged to both sides of the circuit board and diametrically opposed, by which a mutual interference of the sensor devices can be excluded to the greatest extent possible.

In order to enable a proper parallel guidance of the sensor rings in relation to the sensor devices being associated to them, respectively, in addition, the invention suggests the measures as explained in the following.

A ring-shape sliding guiding track for the exact guidance of the output sensor ring is provided at the corresponding side of the circuit board, which sensor ring is arranged on the circuit board opposite to the motor. In addition, the housing of the sliding guiding track may comprise means for the fixation and guidance of wire components such as cables of the circuit board.

According to the invention it is provided that an axial bearing, which guides, axially opposite to the output, the drive shaft in the housing of the motor, shall be arranged as close as possible to the sensor ring both with respect to configuration and space, so that the input/drive sensor ring can be guided in an exact flat manner.

By the provision of a slide bearing for the sensor ring for the output and by a corresponding positioning of the upper axial bearing for the drive shaft it becomes possible to arrange and guide both sensor rings as parallel and concentric as possible in relation to the sensor chips being associated to them, so that axial and angular deviations with respect to tolerances can be kept extremely low and detection errors do rarely occur.

The circuit board can be arranged relative to the input sensor ring in an exact parallel alignment, in that connecting elements are provided with it which are configured to cooperate with a housing of the motor in such a way that an exact distance can be kept between the housing of the motor and the circuit board.

According to a further embodiment of the invention it is provided that the sensor shaft is configured as a hollow shaft for the reception of wiring components. These may be wiring components (cable, data bus) which originate from a further drive unit being arranged between the next arm members of a manipulator. By that the wiring components can be safely guided through the inner of the manipulator and be protected against the mechanics of the drive units.

The invention is characterized by the advantage that only one single integrated circuit board is employed per joint, which circuit board serves for the entire control of just said joint only. Also, hereby it becomes possible in a simple manner to create a connection with other joints, in that the one circuit board of the one joint is connected with the other circuit board of the other joint by means of supply and signal bus lines.

By the omission of complicated wiring and of at least one further circuit board for the output side sensor device altogether a more compact and thus a more light structure of the drive unit can be realized. In total less components are required, by which also the time for assembly and, if applicable, maintenance periods may be reduced, both being associated with cost reduction.

At the same time the hollow sensor shaft for the guidance of the still required wiring components in the center of the drive unit can serve as some kind of protective sleeve for said wiring.

The arrangement of both the sensor device for the output and of the sensor device for the drive/input at one single circuit board proves to be less susceptible to faults and less error-prone. The programming of the evaluation algorithms will be substantially simplified.

Therefore, in this context the invention also relates to a robot with a manipulator having a plurality of arm members, the robot comprising a drive unit according to the afore-mentioned embodiments in at least one joint being arranged between arm members of said manipulator.

Further advantages and features do become apparent from the description of the embodiment as shown in the accompanying drawings, in which

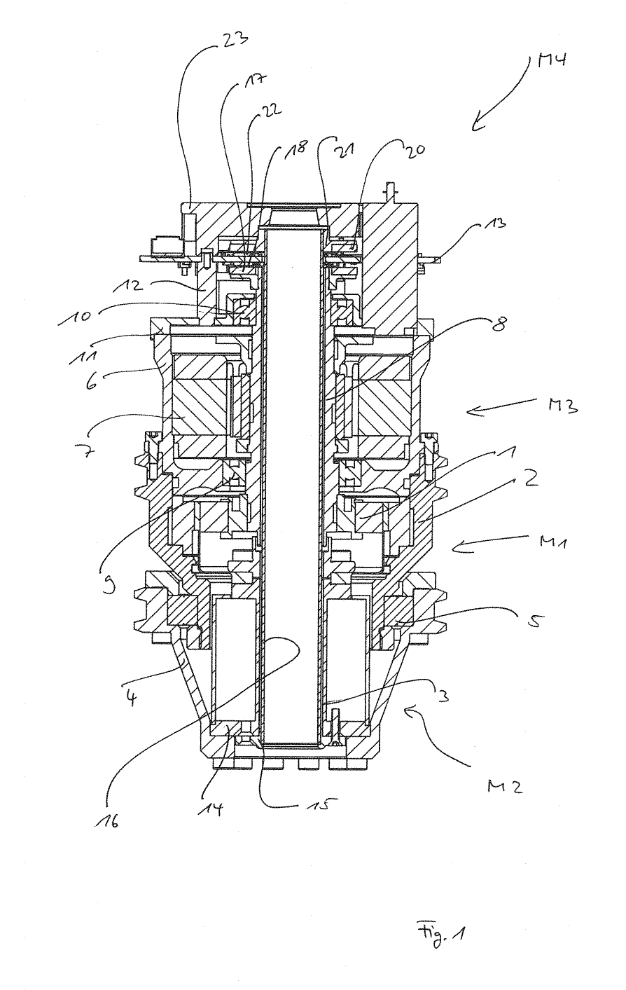

FIG. 1 is an axial longitudinal section along a drive unit according to the invention;

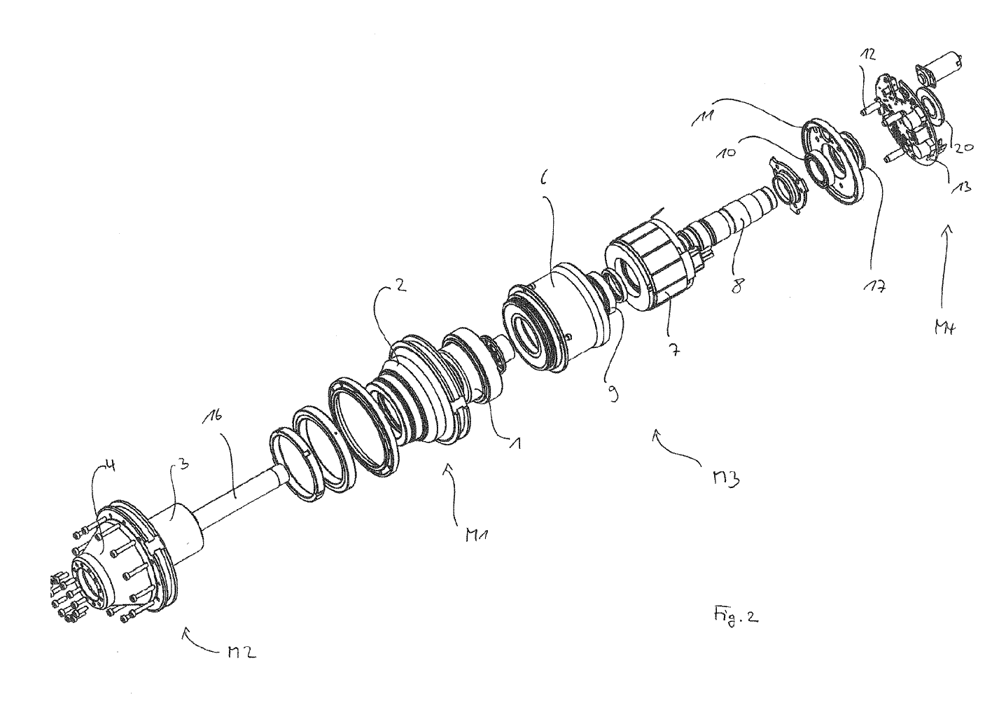

FIG. 2 is an explosive view of this embodiment; and

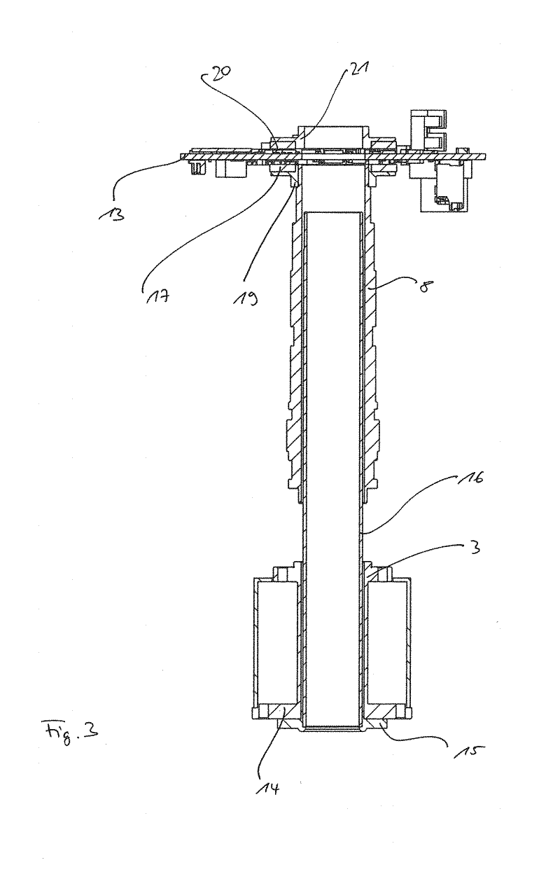

FIG. 3 shows the arrangement of the sensor rings of the drive shaft and of the sensor shaft in sections.

As an example, FIG. 1 shows an embodiment of a drive unit according to the invention in a cross-sectional view along the rotational axis, i.e. in a longitudinal extension of the drive unit.

As can be seen, the drive unit substantially is formed by components and parts, which are configured in a rotational symmetric manner.

According to the invention, a module-type configuration is provided in which several modules are functionally cooperating and engaging with each other along an axial orientation. Each module as such can be singularly exchanged and can be connected by means of connection techniques, which are correspondingly constructed and configured according to the invention, respectively.

The drive unit as shown in FIG. 1 and FIG. 2 substantially comprises four drive modules which are functionally distinct.

A first drive module M1 contains a gear 1, for example a wave gear, which is received in a housing 2. The output element of the gear 1 is connected to a housing 4 of a second drive module M2 by means of an output shaft 3 in a rotationally fixed, i.e. torque-transmitting manner.

The second drive module M2 serves for the output and for that purpose is rotationally fixedly connected with a not-shown axial or arm member of a manipulator or robot arm, while the housing 2 of the first drive module M1 is connected to a further not-shown arm member of said manipulator. The housing 4 of the second drive module M2 is rotatably supported against the housing 2 of the first drive module M1 by means of a radial bearing 5.

Axially opposite to the second drive module M2 a third drive module M3 is fixed to the first drive module M1, which third drive module M3 comprises a housing 6, inside which a motor 7 is arranged, which motor 7 actuates a motor or drive shaft 8.

The drive shaft 8 is rotatably supported by means of a first axial bearing 9 close to the gear 1 and by means of a second axial bearing 10 in a cover 11 for the housing 6 and is thereby centrally supported in the drive unit.

On top of the housing 6 of the third drive module M3 or of the cover 11 associated thereto, respectively, a fourth drive module M4 is fixed by means of connecting supports and spacers 12, which fourth drive module M4 comprises a circuit board 13 or PCB for sensor and control electronics assembly.

The drive shaft 8 of the motor 7, which is formed as a hollow shaft, traverses through the cover 11 and extends to the side of the circuit board 13, which side faces the cover 11.

At its face side the housing 4 of the second drive module M2 is rotationally fixedly bolted by means of a flange 14 with a flange 15 of a sensor shaft 16.

As can be seen in FIG. 1, the sensor shaft 16 traverses the output shaft 3 and the input/drive shaft 8 of the motor 7 with a radial distance and extends through an opening in the circuit board 13 up to the side of the circuit board 13, which side is opposite to the third drive module M3 (In FIG. 3 the sensor shaft 16 is shown in a retracted position so as to illustrate the arrangement inside the hollow drive shaft 8).

The face-side axial end of the drive shaft 8, which faces the circuit board 13, comprises a sensor ring 17, while a sensor chip 18 is arranged on the circuit board 13, which sensor chip is associated to said sensor ring 17 in a corresponding way. The sensor ring 17 is fixed by and on a support ring 19, so that the sensor ring 17 rotates together with the drive shaft 8.

Also, at its face-side axial end the sensor shaft 16 comprises a sensor ring 20, which is fixed in a corresponding support ring 21 as well and which thereby rotates above a sensor chip 22 on the circuit board 13, which sensor chip 22 is associated to said sensor ring 20.

The sensor rings 17 and 20 comprise at least one (not-shown) magnet element, wherein the sensor chips 18 and 22 each are configured to detect the respective positions of the drive shaft 8 and the sensor shaft 16, respectively, by application of the Hall-effect.

A radial guide track or guidance 23 is arranged on the circuit board 13, which is bolted together with the spacers 12, in order to guide the sensor ring 20 of the sensor shaft 16 exactly concentrically and parallel to the sensor chip 22.

In order to exactly concentrically and parallel guide the sensor ring 17 of the drive shaft 8 in relation to the sensor chip 18, the second axial bearing 10 of the third drive module M3 is arranged as close as possible to the circuit board 13.

1. Drive unit for a joint being arranged between two arm members of a manipulator of a robotic system, the drive unit being intended for the rotatory drive of the one arm member in relation to the other arm member, having a motor, which drives a drive shaft, and having an output element, which is connected to the one arm member and which is directly or indirectly set into rotation by means of the drive shaft, wherein the drive unit comprises a circuit board, on which a sensor device with respect to the drive as provided by the drive shaft and a sensor device with respect to the output as provided by the output element are arranged.

2. Drive unit according to claim 1, in which the sensor device for the drive and the sensor device for the output are arranged at opposite sides of the circuit board.

3. Drive unit according to claim 1, in which the drive shaft is formed as a hollow shaft and the output element is rotationally fixedly connected to a sensor shaft, which traverses the drive shaft with a radial distance and which extends up to the circuit board.

4. Drive unit according to claim 3, in which the sensor shaft extends through an opening in the circuit board up to the side of the circuit board, which side is opposite to the motor.

5. Drive unit according to claim 4, in which a sensor ring is arranged at the face-side axial end of the sensor shaft above the circuit board, which sensor ring cooperates with the sensor device for the output.

6. Drive unit according to claim 5, in which a sliding guide for the sensor ring is arranged on the circuit board.

7. Drive unit according to claim 6, in which a housing of the sliding guide comprises means for fixation of wiring components.

8. Drive unit according to claim 3, in which the sensor shaft is formed as a hollow shaft for receiving of wiring components.

9. Drive unit according to claim 3, in which the drive shaft extends up to the circuit board, wherein the sensor device for the drive is arranged at the side of the circuit board, which faces the motor.

10. Drive unit according to claim 9, in which a sensor ring is arranged at the face-side axial end of the drive shaft, which end faces the circuit board, and in which the sensor ring cooperates with the sensor device for the drive.

11. Drive unit according to claim 10, in which the drive shaft is supported by an axial bearing, which is arranged as close as possible to the sensor ring.

12. Drive unit according to claim 5, in which the sensor ring for the drive and the sensor ring for the output are located opposite to each other at both sides of the circuit board in a congruent manner.

13. Drive unit according to claim 12, in which the sensor device being associated to the sensor ring for the output and the sensor device being associated to the sensor ring for the drive are located diametrically opposite to each other at both sides of the circuit board.

14. Drive unit according to claim 12, in which the circuit board comprises connecting elements which are configured to cooperate with a housing of the motor in such a way that the circuit board can be arranged in an exact parallel orientation with respect to the sensor rings.

15. Robot having a manipulator consisting of several arm members and comprising a drive unit according to claim 1 in at least one joint being arranged between arm members of the manipulator.
